(19) United States
(12) Patent Application Publication
(10) Pub. No.: US 2026/0073075 A1
(43) Pub. Date: Mar. 12, 2026

(54) PRIVACY-PRESERVING METHOD FOR PERSONAL BILL RECORD FILTERING AND AMOUNT STATISTICS

(71) Applicant: HANGZHOU DIANZI UNIVERSITY, Hangzhou City (CN)

(72) Inventors: Gengran HU, Hangzhou City (CN); Shuai ZHAO, Hangzhou City (CN); Tingting CUI, Hangzhou City (CN); Lin YOU, Hangzhou City (CN); Xingbing FU, Hangzhou City (CN); Ruifeng ZHENG, Hangzhou City (CN)

(73) Assignee: HANGZHOU DIANZI UNIVERSITY, Hangzhou City (CN)

(21) Appl. No.: 19/384,556

(22) Filed: Nov. 10, 2025

(30) Foreign Application Priority Data
Nov. 11, 2024 (CN) 202411605994.X

(51) Int. Cl. G06F 21/62

(52) U.S. Cl. CPC G06F 21/6245

(57) ABSTRACT

Provided is a privacy-preserving method for personal bill record filtering and amount statistics. A user homomorphically encrypts data involved in personal bills, including bill amount, income-expenditure category, bill description, and occurrence time, and uploads ciphertext data to a server. Then the user inputs three conditions: keywords for the bill description, an interval for the bill amount, and an occurrence time range. The server, according to an AND/OR combination of the three conditions, performs a combination of homomorphic operations on the ciphertext data, and returns all results to the user, and the user performs decryption to recover query results. Finally, the user inputs a required income-expenditure category and a required occurrence time range. The server performs homomorphic operations and returns operation results to the user. The user performs homomorphic decryption to calculate a total amount, thereby completing amount statistics and generating a final query result.

### CROSS REFERENCE TO RELATED APPLICATION

This patent application claims the benefit and priority of Chinese Patent Application No. 202411605994.X, filed with the China National Intellectual Property Administration on Nov. 11, 2024, the disclosure of which is incorporated by reference herein in its entirety as part of the present application.

### TECHNICAL FIELD

The present disclosure relates to the field of privacy protection, and in particular to a privacy-preserving method for personal bill record filtering and amount statistics.

### BACKGROUND

In the wave of rapid development in the field of information technology, key technologies such as big data, artificial intelligence, cloud computing, and mobile Internet are driving social progress and the industrial upgrade. Against this backdrop, various applications and platforms have emerged in significant numbers, accompanied by the massive growth of personal data and enterprise data. While this trend has greatly enriched the digital ecosystem, it has also significantly intensified the potential threat of data breach.

Homomorphic encryption is an outstanding representative of functional encryption algorithms. It can perform computations, which originally need to be done on plaintext, directly on encrypted data without decrypting the data, and is also one of the core technologies for achieving privacy-preserving computing. This means that data owners can authorize third parties to perform data analysis and computations without revealing the content of the original data. This characteristic not only ensures data security but also greatly promotes data circulation and value mining, making it particularly suitable for application scenarios such as personal bills. Data such as amount, time, and description in personal bills of a user can be regarded as personal privacy of the user. These data can be homomorphically encrypted and uploaded to a server. The user can submit queries regarding fields such as amount range, time range, and description, or perform amount statistics based on a time range. The server can then perform homomorphic operations on the ciphertext side and return operation results to the user for decryption. Throughout the entire process, the server only accesses ciphertext data, maximizing the protection of the user's personal privacy. In the field of personal data encryption and privacy protection, symmetric encryption algorithms such as Advanced Encryption Standard (AES) are more mature today for efficiently encrypting personal data. However, symmetric encryption requires ciphertext to be highly random, which limits the possibility of performing direct computations on the ciphertext. Consequently, when computation on the data is needed, it still has to go through the process of decryption first and then computation, which weakens the effectiveness of privacy protection to a certain extent. In recent years, homomorphic encryption technology has gradually gained favor due to its support for computation on ciphertext. However, constrained by the characteristics of cryptographic algorithms, how to design corresponding homomorphic versions for numerous specific operations in concrete application scenarios remains a subject worthy of in-depth research. Personal bills are an important type of personal data closely related to everyone, and also important scenario data requiring privacy protection.

### SUMMARY

To solve the technical problems existing in the prior art, the present disclosure provides a privacy-preserving method for personal bill record filtering and amount statistics, adopting the specific technical solutions as follows:

A privacy-preserving method for personal bill record filtering and amount statistics, including following steps:
step 1: generating personal bill records by a user, where each record Rᵢ includes a bill amount Aᵢ, an income-expenditure category Cᵢ, a bill description string Dᵢ, and an occurrence time Tᵢ;
step 2: performing, by the user, homomorphic encryption on the bill amount Aᵢ, the occurrence time Tᵢ, and the bill description string Dᵢ using a Paillier encryption system;
step 3: uploading, by the user, all homomorphically encrypted ciphertext data, a public key held by the user, and auxiliary information to a server managing bills, and sharing a private key with a trusted third party;
step 4: performing, by the user, bill record filtering based on three filtering conditions that support AND or OR connections, where the three filtering conditions include: a keyword string K for bill description, a bill amount interval [AL, AU], and a record occurrence time interval [TL, TU];
step 5: performing, by the user, homomorphic encryption on the three filtering conditions, and uploading the three filtering conditions after the encryption together with a bill description string length len(Dᵢ) to the server;
step 6: performing, by the server, a homomorphic operation based on an overall filtering condition, and sending an operation result to the trusted third party;
step 7: performing, by the trusted third party, homomorphic decryption on the operation result to obtain records meeting the overall filtering condition, and returning indexes of hit records to the server;
step 8: returning, by the server, corresponding ciphertext records to the user according to the indexes of the hit records; and performing, by the user, homomorphic decryption to obtain plaintext, thereby completing record filtering;
step 9: starting bill statistics by the user: inputting a to-be-counted income-expenditure category SC and a bill occurrence time range [STL, STU], encrypting the bill occurrence time range, and then uploading the encrypted bill occurrence time range and the to-be-counted income-expenditure category SC to the server;
step 10: performing, by the server, a homomorphic operation on a bill amount of each record through interaction with the trusted third party, and returning an operation result RES₂ to the user; and
step 11: performing, by the user, homomorphic decryption on the operation result RES₂ to calculate a total amount, thereby completing amount statistics.

Further, the step 2 specifically includes:
step 2.1: generating, by the user, a key pair (pk, sk) by using the Paillier encryption system, where pk represents the public key and sk represents the private key;
step 2.2: multiplying the bill amount Aᵢ by 100 to obtain a non-negative integer saᵢ, and encrypting the non-negative integer saᵢ with the public key pk by the user to obtain a ciphertext E(saᵢ), that is, an encrypted bill amount;
step 2.3: converting the occurrence time Tᵢ into a timestamp tsᵢ, and encrypting the timestamp tsᵢ with the public key pk by the user to obtain a ciphertext E(tsᵢ), that is, an encrypted time; and
step 2.4: padding a right side of the bill description string Dᵢ with null characters until a character upper limit l is reached, then encoding the padded bill description string into a positive integer dᵢ, and encrypting the positive integer dᵢ with the public key pk by the user to obtain a ciphertext E(dᵢ).

Further, in step 3, all the homomorphically encrypted ciphertext data includes: E(saᵢ), E(tsᵢ), and E(dᵢ); the auxiliary information includes: the income-expenditure category Cᵢ, and the bill description string length len(Dᵢ).

Further, the step 5 specifically includes:
step 5.1: multiplying an upper bound and a lower bound of the bill amount interval [AL, AU] by 100 to obtain corresponding non-negative integers sal and sau, and then encrypting the upper and lower bounds after the multiplication using the public key pk to obtain corresponding ciphertexts (E(sal), E(sau));
encoding and converting the keyword string K of the bill description into a non-negative integer d, and encrypting the non-negative integer d with the public key pk to obtain a ciphertext E(d);
converting an upper bound and a lower bound of the record occurrence time interval [TL, TU] into corresponding timestamps (tsl, tsu), and then separately encrypting the timestamps corresponding to the upper and lower bounds with the public key pk to obtain corresponding ciphertexts (E(tsl), E(tsu)); and
step 5.2: connecting, by the user, the three ciphertexts (E(sal), E(sau)), E(d), and (E(tsl), E(tsu)) of the three filtering conditions according to an input AND/OR condition, and then uploading the connected ciphertexts together with the bill description string length len(D₁) to the server, where an expression for the connection is as follows:

$${FC}_{i} = ( ( E ( sal ) , E ( sau ) ) , conj , E ( d ) , conj , ( E ( tsl ) , E ( tsu ) ) ) ,$$

where a conjunction conj=“AND” or conj=“OR”.

Further, the step 6 specifically includes:
step 6.1: according to the ciphertexts E(sal) and E(sau) for amount interval filtering, for the encrypted amount E(saᵢ) in each ciphertext bill, performing Paillier subtraction homomorphic operations between E(sal) and E(saᵢ), and between E(sau) and E(saᵢ) respectively, to obtain operation results denoted as αᵢ and βᵢ;
according to the ciphertext E(d) for bill description filtering, for the encrypted bill description E(dᵢ) in each ciphertext bill and for j=0, . . . , l−len(K), performing subtraction homomorphic operations between E(d<<j) and E(dᵢ), and then integrating operation results into a vector γᵢ=(γᵢ⁽⁰⁾, . . . , γᵢ^{(l-len(K))});
according to the corresponding ciphertexts E(tsl) and E(tsu) for occurrence time interval filtering, for the encrypted time E(ts₁) in each ciphertext bill, performing subtraction homomorphic operations between E(tsl) and E(ts₁), and between E(tsu) and E(ts₁) respectively, to obtain operation results denoted as δᵢ and εᵢ; and
step 6.2: combining, by the server, the operation results according to an AND/OR conjunction submitted by the user, where an expression for each operation result after the combination is as follows:

$${FR}_{i} = ( ( {α}_{i} , {β}_{i} ) , conj , {γ}_{i} , conj , ( {δ}_{i} , {ε}_{i} ) )$$

and sending all the operation results FRᵢ after the combination to the trusted third party.

Further, the step 7 specifically includes:
step 7.1: performing, by the trusted third party, homomorphic decryption on each operation result FRᵢ by using the private key sk to obtain a result:

$$D ( {FR}_{i} ) = ( ( D ( {α}_{i} ) , D ( {β}_{i} ) ) , conj , D ( {γ}_{i} ) , conj , ( D ( {δ}_{i} ) , D ( {ε}_{i} ) ) ) ;$$

when D(αᵢ)<0 and D(βᵢ)>0, adding a current index i into a hit index set AI for amount filtering;
when a decoding result of each component of the vector D(γᵢ) has a character-wise Hamming weight not exceeding len(Dᵢ)−len(K), adding the current index i into a hit index set DI for bill description filtering;
when D(δᵢ)<0 and D(εᵢ)>0, adding the current index i into a hit index set TI for time filtering; and
step 7.2: calculating, by the trusted third party, an intersection or a union of the three hit index sets AI, DI, and TI according to the conjunction conj=“AND” or conj=“OR” to form a result index set I, and returning the result index set I to the server.

Further, the step 8 specifically includes:
step 8.1: recording, by the server, corresponding ciphertext bills according to the index set I returned by the trusted third party, to form a result RES₁, and sending the result to the user; and
step 8.2: after receiving the result RES₁, decrypting, by the user, E(saᵢ), E(tsᵢ), and E(dᵢ) corresponding to each record by using the private key sk, to obtain the multiplied amount saᵢ, the timestamp tsᵢ, and the integer dᵢ; then reducing saᵢ by 100 times to obtain an actual amount aᵢ, converting the timestamp tsᵢ to the occurrence time Tᵢ, and decoding the integer dᵢ and removing the null characters on the right side to obtain D, thereby completing record filtering.

Further, the step 9 specifically includes:
step 9.1: inputting, by the user, the to-be-counted income-expenditure category SC and the bill occurrence time range [STL, STU]; and
step 9.2: converting, by the user, an upper bound and a lower bound of the bill occurrence time range [STL, STU] into timestamps tssl and tssu respectively, encrypting the timestamps corresponding to the upper and lower bounds with the public key pk to obtain corresponding ciphertexts (E(tssl), E(tssu)), and submitting the ciphertexts (E(tssl), E(tssu)) of the bill occurrence time range and the income-expenditure category SC to the server.

Further, the step 10 specifically includes:
step 10.1: performing, by the server according to the corresponding ciphertexts E(tssl) and E(tssu) of the bill occurrence time range, Paillier subtraction homomorphic operations between E(tssl) and E(ts₁), and between E(tssu) and E(ts₁) for the encrypted time E(ts₁) in each ciphertext bill, to obtain operation results λᵢ and μᵢ, and sending the operation results to the trusted third party;
step 10.2: decrypting, by the trusted third party, each λᵢ and μᵢ by using the private key sk; when D(λᵢ)<0 and D(μᵢ)>0, adding the current index i into the hit index set TI, and finally returning TI to the server; and
step 10.3: performing, by the server according to the hit index set TI and the to-be-counted income-expenditure category SC submitted by the user, an additive homomorphic operation on the encrypted amount in each ciphertext bill that meets the to-be-counted income-expenditure category and the hit index set TI, and returning an operation result RES₂ to the user.

Further, step 11 specifically includes: performing, by the user, homomorphic decryption on the operation result RES₂ to obtain the total amount, then reducing the total amount by 100 times to complete the amount statistics, and generating a final query result.

The present disclosure has the following advantages:

The present disclosure supports encrypted protective storage for sensitive data such as amount, description, and time of each record in personal bills.

The present disclosure supports filtering of bill records based on the amount interval, time interval, and bill description keywords, and supports AND or OR connection of the three filtering conditions.

The present disclosure supports encrypted amount statistics for bill records based on the income-expenditure category and time interval.

By exploring the ciphertext characteristics of homomorphic encryption and researching range proof technology for ciphertext data, the present disclosure solves the problem that range proof operations on ciphertext cannot be implemented during record filtering in the existing privacy protection algorithms for personal bills.

### BRIEF DESCRIPTION OF THE DRAWINGS

FIG. 1 is a schematic flowchart of a privacy-preserving method for personal bill record filtering and amount statistics according to the present disclosure.

### DETAILED DESCRIPTION OF THE EMBODIMENTS

To make the objectives, technical solutions, and advantages of the present disclosure clearer, the present disclosure is described in further detail below with reference to the drawings and embodiments.

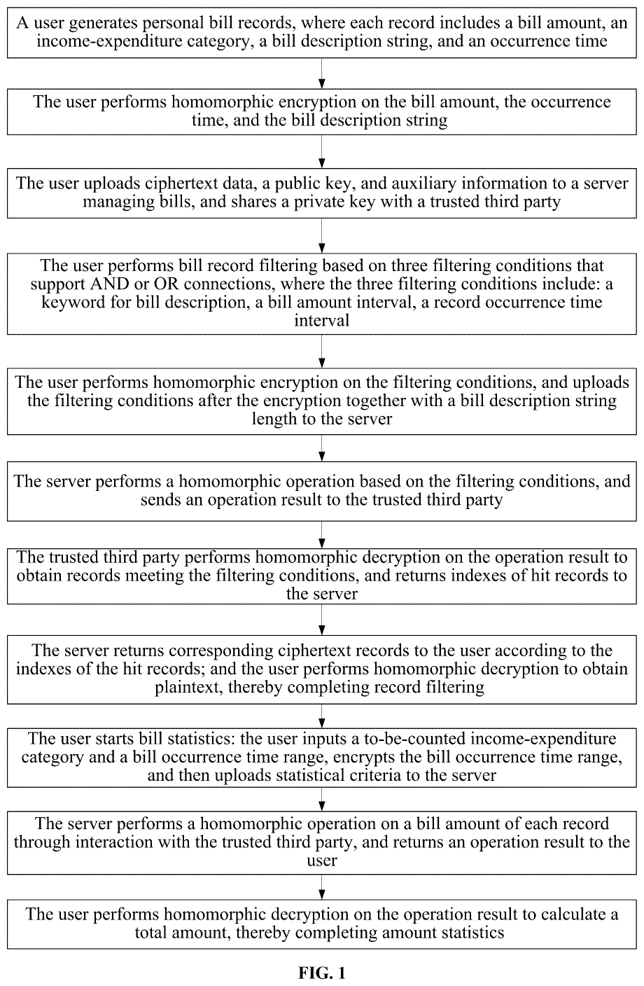

The present disclosure provides a privacy-preserving method for personal bill record filtering and amount statistics. A user can homomorphically encrypt data involved in personal bills, including bill amount, income-expenditure category, bill description, and occurrence time, and upload ciphertext data to a server. Then the user inputs three conditions: keywords for the bill description, an interval for the bill amount, and an occurrence time range. The server, according to an AND/OR combination of the three conditions, performs a combination of homomorphic operations on the ciphertext data, and returns all results to the user, and the user performs decryption to recover query results. Finally, the user inputs a required income-expenditure category and a required occurrence time range. The server performs homomorphic operations and returns operation results to the user. The user performs homomorphic decryption to calculate a total amount, thereby completing amount statistics and generating a final query result. Specifically, as shown in FIG. 1, the method includes the following steps:
Step 1: A user generates personal bill records, where each record Rᵢ includes a bill amount Aᵢ, an income-expenditure category Cᵢ, a bill description string D, and an occurrence time T.
Step 2: The user performs homomorphic encryption on the bill amount Aᵢ, the occurrence time Tᵢ, and the bill description string Dᵢ using a Paillier encryption system.
Step 3: The user uploads all homomorphically encrypted ciphertext data, a public key held by the user, and auxiliary information to a server managing bills, and shares a private key with a trusted third party.
Step 4: The user performs bill record filtering based on three filtering conditions that support AND or OR connections, where the three filtering conditions include: a keyword string K for bill description, a bill amount interval [AL, AU], and a record occurrence time interval [TL, TU].
Step 5: The user performs homomorphic encryption on the filtering conditions, and uploads the filtering conditions after the encryption together with a bill description string length len(Dᵢ) to the server.
Step 6: The server performs a homomorphic operation based on an overall filtering condition, and sends an operation result to the trusted third party.
Step 7: The trusted third party performs homomorphic decryption on the operation result to obtain records meeting the overall filtering condition, and returns indexes of hit records to the server.
Step 8: The server returns corresponding ciphertext records to the user according to the indexes of the hit records; and the user performs homomorphic decryption to obtain plaintext, thereby completing record filtering.
Step 9: The user starts bill statistics: inputting a to-be-counted income-expenditure category SC and a bill occurrence time range [STL, STU], encrypting the bill occurrence time range, and then uploading ciphertext of the bill occurrence time range and the to-be-counted income-expenditure category SC to the server.
Step 10: The server performs a homomorphic operation on a bill amount of each record through interaction with the trusted third party, and returns an operation result RES₂ to the user.
Step 11: The user performs homomorphic decryption on the operation result RES₂ to calculate a total amount, thereby completing amount statistics.

By adopting the aforementioned method, the specific implementation example of bill filtering and amount statistics by the user in the present disclosure listed below only uses the case where a modulus n=p*q in Paillier encryption is 128 bits for explanation. In actual operation, a security parameter with n being at least 1024 bits should be used. The specific process is as follows:

(1) Paillier encryption parameter settings:

$$p = 121537695572010 \; 40739 ,$$

$$q = 11 \; 7209843661353797 \; 73 ,$$

$$pk : N = p * q = 1424541429695655157844962738846095722 \; 47 ,$$

$$sk : λ = ( p - 1 ) * ( q - 1 ) = 142454142969565515760621519961273151736 ,$$

$$μ = {λ}^{- 1} mod N = 138764946862713715597479501644265181870 .$$

(2) Assume the user generates a total of 10 bill records in September 2024, as shown in Table 1:

TABLE 1
Original Bill Data

| Bill | | | | Income- |
|---|---|---|---|---|
| Num- | | Bill | Bill | Expenditure |
| ber | Bill Time | Amount | Description | Category |
| 0 | 2024-09-01 16:05:58 | 431.55 | E-commerce | Expense |
| 1 | 2024-09-05 19:06:19 | 198 | Train Ticket | Expense |
| 2 | 2024-09-07 15:19:15 | 22.69 | Utility Bills | Expense |
| 3 | 2024-09-10 06:24:25 | 53.59 | E-commerce | Expense |
| 4 | 2024-09-12 04:58:37 | 582.31 | Flight Ticket | Expense |
| 5 | 2024-09-13 13:09:07 | 100 | Phone Recharge | Expense |
| 6 | 2024-09-16 15:21:11 | 1174.95 | Flight Ticket | Expense |
| 7 | 2024-09-20 16:04:33 | 6901.72 | Salary | Income |
| 8 | 2024-09-26 13:52:18 | 24.62 | Utility Bills | Expense |
| 9 | 2024-09-29 06:49:21 | 861.08 | Labor Fee | Income |

(3) The user first processes three columns of private data: time, amount, and description, and encrypts the three columns of private data using the public key pk. Results after the encryption are shown in Table 2:

TABLE 2
Encrypted Bill Column Data

| Encrypted Bill Time | Encrypted Bill Amount | Encrypted Bill Description |
|---|---|---|
| 469361125828443899846483 | 816101057915589989280873 | 231964242289862533490002 |
| 351616306928555138423563 | 375428588162187269105857 | 602132095825271556825085 |
| 066397429728251031659173 | 001288368637825569552211 | 132285669430673620035789 |
| 8591 | 892 | 9180 |
| 692726693897195150397686 | 147144883589303359526651 | 170621009076686436885688 |
| 268789345921283992329800 | 344604235690337727192748 | 305246922172030228831242 |
| 025917723108194971236992 | 660903808937325510536597 | 096290499317362376093747 |
| 3737 | 47862 | 55553 |
| 101900956449979575495308 | 143361541213014493143279 | 115576670690738286837014 |
| 918451537332148460444308 | 173696792792382712203978 | 492724387950991410994270 |
| 539568924359522739520226 | 196223549088306366266895 | 496966079359302907581357 |
| 00599 | 15255 | 33820 |
| 197292037224082468265101 | 121408952482768124168122 | 612765625350957019551900 |
| 446725030410128402979904 | 109415593864488390257055 | 825273437665469981441953 |
| 797128696710274735646387 | 443292369909068401438171 | 767939755951295960086115 |
| 59858 | 27112 | 257 |
| 183263919132386698821742 | 895433966779950570337644 | 438241185939121581167421 |
| 556877584387972311433502 | 513317112012504538115591 | 592286986671372010176357 |
| 736589461311802060237599 | 184316847879497469613644 | 607505907730930260521721 |
| 8136 | 8334 | 382 |
| 196011149698212999470532 | 127249115150461716560442 | 655570204347182854256680 |
| 920440399310174820763144 | 840105856060580430693467 | 730456248396256416538096 |
| 180214888465274935261692 | 703645830464184844159091 | 682142918618051854715126 |
| 49163 | 67932 | 2783 |
| 111242446604692826858499 | 895910336153240752627810 | 160492028564943204696172 |
| 488601031105604124083386 | 182684963433497985471988 | 524335372337848330022695 |
| 661469848871316730537464 | 176652952634559993559902 | 467561650511614206443108 |
| 58908 | 1340 | 23171 |
| 347257727476237032104412 | 632981839066982740707408 | 227593933096735643045022 |
| 698507476430371415028973 | 584779113570620922000100 | 048234911108005586825717 |
| 112864365892549965819238 | 210059332452936218157490 | 483186455694973512664887 |
| 8156 | 1450 | 688 |
| 864474174870143758151184 | 144874986069052633029546 | 727028152295881717912936 |
| 885906663486065124293384 | 288625097733781993826769 | 050563704295414004808072 |
| 793885364610019333567051 | 174815643410611339440901 | 109213288860099255976897 |
| 0015 | 53352 | 7597 |
| 122845661665452172008289 | 163327271819107493958513 | 195360702166761246989330 |
| 422698227993504068999251 | 688451904697953365617330 | 593546586710845271168793 |
| 518919746226592267757010 | 990686091589995299830113 | 987290719341275283178959 |
| 8308 | 92412 | 34024 |

Then, the user uploads all the above ciphertext data, the held public key, and the auxiliary information: income-expenditure category and description string length, to the server.

(4) The user needs to filter bill records that occurred between September 10 and September 20 and whose bill description contains “Ticket”, that is, an AND connection between occurrence time and bill description, where a specific expression is as follows:

$$[ TL , TU ] = [ 2024 / 09 / 10 \; 00 : 00 , 2024 / 09 / 20 \; 23 : 59 : 59 ] AND D = ‘ Ticket ’$$

(5) The user processes the filtering conditions, including:

First, the user converts the occurrence time [TL, TU] into timestamps (tsl, tsu)=(1725897600, 1726847999), and homomorphically encrypts the timestamps into ciphertexts (E(tsl), E(tsu)) as
(10158395881406777149774239903382210838560302277666039258515014283884972 671858,
19997655163751078721757901974142906317158721676128140493695034395126194 931910).

Then, the user encodes the keyword string K of the bill description into a large integer d=92811616281972, and homomorphically encrypts the large integer into a ciphertext:

$$E ( d ) = 1.4027678541534099900420143243633916620682248209229288295104184320873847320076 \times {10}^{76}$$

Finally, the user uploads the above ciphertext data to the server.

(6) For the encrypted description E(d₁) in each ciphertext bill and for j=0, . . . , 9, the server performs subtraction homomorphic operations between E(d<<j) and E(dᵢ) according to the ciphertext E(d) of the bill description thus correspondingly calculating each component

$${γ}_{i}^{( j )} = {E ( d )}^{25 {6}^{j}} * {E ( {d}_{i} )}^{- 1} mod {N}^{2} ,$$

and then integrates the components into a vector γᵢ=(γᵢ⁽⁰⁾, . . . , γᵢ⁽⁹⁾). All values of

$${γ}_{i}^{( j )}$$

are shown in Table 3:

TABLE 3
$Distribution of All {γ}_{i}^{( j )} Values$

| | i | | | | | | | | | |
|---|---|---|---|---|---|---|---|---|---|---|
| j | 0 | 1 | 2 | 3 | 4 | 5 | 6 | 7 | 8 | 9 |
| 0 | 72 ... 98 | 65 ... 50 | 11 ... 35 | 20 ... 09 | 15 ... 53 | 18 ... 93 | 20 ... 74 | 72 ... 80 | 43 ... 45 | 12 ... 50 |
| 1 | 99 ... 98 | 10 ... 59 | 23 ... 90 | 97 ... 47 | 25 ... 87 | 12 ... 10 | 17 ... 23 | 71 ... 64 | 16 ... 09 | 48 ... 49 |
| 2 | 56 ... 41 | 16 ... 11 | 44 ... 89 | 19 ... 43 | 12 ... 73 | 29 ... 13 | 26 ... 33 | 14 ... 03 | 15 ... 78 | 19 ... 04 |
| 3 | 15 ... 35 | 10 ... 54 | 63 ... 45 | 15 ... 83 | 64 ... 38 | 11 ... 76 | 18 ... 70 | 16 ... 26 | 35 ... 78 | 63 ... 62 |
| 4 | 17 ... 00 | 16 ... 26 | 14 ... 55 | 23 ... 34 | 81 ... 89 | 99 ... 50 | 85 ... 56 | 21 ... 37 | 28 ... 75 | 39 ... 78 |
| 5 | 11 ... 57 | 99 ... 90 | 44 ... 57 | 10 ... 08 | 37 ... 24 | 53 ... 28 | 79 ... 95 | 17 ... 63 | 99 ... 17 | 10 ... 73 |
| 6 | 11 ... 46 | 10 ... 86 | 12 ... 56 | 19 ... 61 | 18 ... 40 | 16 ... 71 | 15 ... 53 | 22 ... 23 | 10 ... 93 | 15 ... 03 |
| 7 | 91 ... 86 | 74 ... 48 | 14 ... 03 | 61 ... 04 | 77 ... 39 | 15 ... 75 | 14 ... 84 | 76 ... 44 | 56 ... 21 | 16 ... 11 |
| 8 | 15 ... 97 | 17 ... 84 | 12 ... 75 | 26 ... 61 | 24 ... 75 | 14 ... 57 | 37 ... 38 | 83 ... 62 | 15 ... 37 | 19 ... 06 |
| 9 | 17 ... 69 | 73 ... 57 | 97 ... 25 | 16 ... 96 | 12 ... 94 | 58 ... 78 | 39 ... 05 | 18 ... 10 | 13 ... 07 | 18 ... 25 |

Then, according to the corresponding ciphertexts E(tsl) and E(tsu) for time interval filtering, for the encrypted time E(tsᵢ) in each ciphertext bill, the server performs subtraction homomorphic operations between E(tsl) and E(tsᵢ), and between E(tsu) and E(tsᵢ) respectively. Vectors composed of each result δᵢ and εᵢ are:
δ=[13463170233930527470563281441865029531766551120939264945410135609626988 869302, 11499713527326509401381467682673531206819467045351199628526335396238420151922, 3243848598522524950849368120873727274596388758897372368324491342519248755373, 9892716805280476207220392543541127122020138503430168742113457253887303427507, 13108602504211291257088820480352906541974968366795144078347950824784723879545, 18164916637122949809881843078406766360217137852805280037735585304538343776129, 14589908209245321461961252159147176337642873358934309187746513272354286112881, 14040742410054644869280327038658381993111597270671890716371177042686049885032, 2800770334402974074309719382159764613039545092644394495650071920198287193616, 11057163255354598373888086034321436774730567398454290137918003984682461957728], ε=[69395041592237854621189427086522908452009681379057545487964737601517022 16591, 4632166797439119629296464650031124398907630118797650364888128003880251800352, 7323775054080470051974325433325967913568217878715650882496115019487727941081, 19694631212149610412795789785939740723890199813612842431401485982455911878791, 2570589168823106105111396393593873132015030956662332438322347006075926891403, 7989445568309486685245950021321958988306940894079944584686488891621797398018, 9348494759585828045133591100626914930561843621779028734474898110026302498619, 10871913269329390749705965113966377929998653360055387903574728253255075426091, 5453030980178039011463709199674526728073980294815054540635696394553190861030, 5435292252715467667745922303607589995850368053423424901778179722090123839039].

The server obtains each operation result expressed as FRᵢ=(γᵢ, AND, (δᵢ, εᵢ)), and sends each operation result to the trusted third party.

(7) The trusted third party performs homomorphic decryption on the received operation results by using the private key.

First, the trusted third party obtains a decryption result vector D(γᵢ) of the bill description, and then decodes the decryption result vector. For example, for the record with the bill description ‘Train Ticket’, the corresponding decryption result vector D(γ₁) after decoding is as follows:

[‘Train Tic\x16\xfc\x10\x94\x9a\x8c’,
‘Train Ti\x0f\x02\x02\x08\x9a\x8c\x00’,
‘Train T\x14\xfa\x07\xfa\x0e\x8c\x00\x00’,
‘Train \x00\x00\x00\x00\x00\x00\x00\x00\x00’,
‘Traim\xcb\xeb\x05\xf8\x05\xflt\x00\x00\x00’,
‘Trai\x19\xb6\xf0\xfd\xfd\xf7et\x00\x00\x00’,
‘Tra\x15\x04\xbc\xe9\x03\xefket\x00\x00\x00’,
‘Tr\r\x00\n\xb4\xee\xf5cket\x00\x00\x00’,
‘T\xld\xf8\x06\x02\xba\xe0icket\x00\x00\x00’,
‘\x00\x08\xfd\xfe\x08\xacTicket\x00\x00\x00’].

Then, for each component D(γᵢ^{(j)}), it is analyzed whether the Hamming weight of the decoding result, namely, the number of results that are not null characters (\x00), does not exceed an upper limit of error characters len(Dᵢ)−len(K). For the ‘Train Ticket’ bill record with i=1, the error upper limit is 12−6=6, and in the vector above, ‘Train \x00\x00\x00\x00\x00\x00\x00\x00\x00’ meets the condition; therefore, i=1 is added to a description hit index set DI. Similarly, two other bill descriptions ‘Flight Ticket’ also meet the condition; therefore, DI={1, 4, 6}.

Then, decryption results D(δᵢ) and D(εᵢ) for the occurrence time are obtained, and results after integration are as follows:

$$D ( δ ) = [ 719642 , 363221 , 204045 , - 23065 , - 190717 , - 306547 , - 573671 , - 921873 , - 1432338 , - 1666161 ] ,$$

$$D ( ε ) = [ 1670041 , 1313620 , 1154444 , 927334 , 759682 , 643852 , 376728 , 28526 , - 481939 , - 715762 ] ,$$

Based on the above results, the index i satisfying D(δᵢ)<0 and D(εᵢ)>0 is added to a time hit index set TI, obtaining TI={4, 5, 6, 7, 8}.

Finally, according to the conjunction AND, an intersection of the sets DI and TI is calculated to obtain a result index I={4, 6}, and return the result index to the server.

(8) The server, according to the result index I, sends the ciphertext bill records corresponding to i=4, 6 to the user. After receiving the result RES₁, the user performs decryption by using the private key sk, and performs operations including reducing the amount by 100 times, restoring the timestamp, and decoding the description, to obtain the following two bill records, as shown in Table 4, thereby completing record filtering.

TABLE 4
Filtered Bill Records after Decryption

| Bill | | | | Income- |
|---|---|---|---|---|
| Num- | | Bill | Bill | Expenditure |
| ber | Bill Time | Amount | Description | Category |
| 4 | 2024-09-12 04:58:37 | 582.31 | Flight Ticket | Expense |
| 6 | 2024-09-16 15:21:11 | 1174.95 | Flight Ticket | Expense |

(9) The user needs to count the total of all expenditures between September 12 and September 30, specifically expressed as follows:
[STL,STU]=[2024/09/12 00:00:00, 2024/09/30 23:59:59], count expenditures.

The user first converts [STL,STU] into corresponding timestamps (E(tssl), E(tssu))=(1726070400, 1727711999), and homomorphically encrypts the timestamps (E(tssl), E(tssu)) as (652671613548992413802563833273908567604689898318394888018334677541208059017, 19310890201811538005727922487379357887683751373799615605582544992570056207975)

Finally, the user submits the ciphertexts and “count expenditures” to the server.

(10) According to the ciphertexts E(tssl) and E(tssu) corresponding to the statistical time, for the ciphertext timestamp E(tsᵢ) in each ciphertext bill, the server performs Paillier subtraction homomorphic operations between E(tssl) and E(tsᵢ), and between E(tssu) and E(tsᵢ) respectively, calculates each λᵢ and μᵢ, and performs integration to obtain:
λ=[3046549642287640044538328533559856966412700504063661889778748996593678293716, 8757089095697488610270276704141852410879958489974872780531812595710234272876, 13636942704174517014972864765812254824066327419294869392087561030215731387376, 18731429736222016091187527632520761500667022618074391680843090295716637360244, 14206556484256932719527161949641523079125916264211491228252128674406102371073, 9656874512138061641883987304010543990017143685984478638464581298519959141829, 3112988426557266679153345947378011396355592976419419131329840569320787152875, 14405416112602854111392410205193823231892411843528471667061407424042058774386, 8959312357396951780695301954496209138340470610043117992094131117286374209620, 15677530929068055227216879118686393425191649834053563962024491931646382890601],
μ=[15234902789116333461244695455982677925169887086552311208495137019547499395927, 7140322143835225034411145869305786518232755739808472053503772057812192327859, 15726542751336720288742834536370307984846674312639391168171584074694792914467, 10480655681187212982247526950661126012241612473937526362310354615054531839335, 5950616639569219447986760448890311692645668204185291777719472497247613862508, 3714527715807214844986343847073633154087309829678851218790839851136577077101, 8240518179451723291384926875904695492774451167278773656746207352879532404022, 19406556228357907150551723938796117020508546848430244298981734887688972339120, 9557008623347686597844483864978822461148636154420884812155867912788246975092, 9086942514942974550331383714403227408682415687696922256052830519378468096654].

The server sends the integrated results to the trusted third party. The trusted third party performs decryption and sign processing on each Aᵢ and μᵢ by using the private key sk, obtaining results D(λᵢ) and D(μᵢ), and performs integration to obtain:

$$D ( λ ) = [ 892442 , 536021 , 376845 , 149735 , - 17917 , - 133747 , - 400871 , - 749073 , - 1259538 , - 1493361 ] ,$$

$$D ( μ ) = [ 2534041 , 2177620 , 2018444 , 1791334 , 1623682 , 1507852 , 1240728 , 892526 , 382061 , 148238 ] .$$

When D(λᵢ)<0 and D(μᵢ)>0, the index i is added into a hit index set TI, obtaining the result TI={4, 5, 6, 7, 8, 9}.

According to the hit index TI and the income-expenditure category SC submitted by the user, the server performs an additive homomorphic operation on the encrypted amount E(saᵢ) in each ciphertext bill record that meets the income-expenditure category and the hit index. In TI, records 4, 5, 6, and 8 belong to the expenditure category. Therefore, operation is performed on the encrypted amounts corresponding to these records, obtaining the result as follows:

$${RES}_{2} = 2.488559241975645618594798028961946995308086765449337272794511232330664746083 \times {10}^{75}$$

The operation result is returned to the user.

(11) The user decrypts the result RES₂ to obtain the plaintext 188188, and then reduces it by 100 times, to complete the amount statistics, that is, the total of all expenditures between September 12 and September 30 is 1881.88=582.31+100+1174.95+24.62 yuan, as shown in Table 5.

TABLE 5
Decrypted Bill Record Amount Statistics

| Bill | | | | Income- |
|---|---|---|---|---|
| Num- | | Bill | Bill | Expenditure |
| ber | Bill Time | Amount | Description | Category |
| 4 | 2024-09-12 04:58:37 | 582.31 | Flight Ticket | Expense |
| 5 | 2024-09-13 13:09:07 | 100 | Phone Recharge | Expense |
| 6 | 2024-09-16 15:21:11 | 1174.95 | Flight Ticket | Expense |
| 8 | 2024-09-26 13:52:18 | 24.62 | Utility Bills | Expense |
| Sum | / | 1881.88 | / | / |

In summary, by exploring the mechanism of sign discrimination for homomorphic subtraction results in homomorphic encryption algorithms, the present disclosure overcomes the limitation that interval discrimination operations cannot be implemented in existing encryption algorithms. By exploring the relationship between string vector subtraction and large integer representation, the present disclosure realizes a substring matching mechanism for keywords and strings. The method of the present disclosure not only encrypts and stores numerical data such as the amount and time of user's personal bills, as well as string data such as descriptions, but also supports the user to query bills and perform preliminary amount statistics based on these fields. Throughout the entire process, the server can only access the encrypted data of these private fields, greatly enhancing the privacy protection level of the personal bill data of the user.

The above described are merely preferred implementations of the present disclosure rather than limitations to the present disclosure in any form. Although the implementation process of the present disclosure is described in detail with reference to the foregoing embodiments, those skilled in the art can still make modifications to the technical solutions described in the foregoing embodiments, or make equivalent replacement to some of the technical features. Any modifications and equivalent substitutions made within the spirit and principle of the present disclosure should be included within the protection scope of the present disclosure.

What is claimed is:

1. A privacy-preserving method for personal bill record filtering and amount statistics, comprising following steps:
step 1: generating personal bill records by a user, wherein each record Rᵢ comprises a bill amount Aᵢ, an income-expenditure category Cᵢ, a bill description string Dᵢ, and an occurrence time T;
step 2: performing, by the user, homomorphic encryption on the bill amount Aᵢ, the occurrence time Tᵢ, and the bill description string Dᵢ using a Paillier encryption system;
step 3: uploading, by the user, all homomorphically encrypted ciphertext data, a public key held by the user, and auxiliary information to a server managing bills, and sharing a private key with a trusted third party;
step 4: performing, by the user, bill record filtering based on three filtering conditions that support AND or OR connections, wherein the three filtering conditions comprise: a keyword string K for bill description, a bill amount interval [AL, AU], and a record occurrence time interval [TL, TU];
step 5: performing, by the user, homomorphic encryption on the three filtering conditions, and uploading the three filtering conditions after the encryption together with a bill description string length len(Dᵢ) to the server;
step 6: performing, by the server, a homomorphic operation based on an overall filtering condition, and sending an operation result to the trusted third party;
step 7: performing, by the trusted third party, homomorphic decryption on the operation result to obtain records meeting the overall filtering condition, and returning indexes of hit records to the server;
step 8: returning, by the server, corresponding ciphertext records to the user according to the indexes of the hit records; and performing, by the user, homomorphic decryption to obtain plaintext, thereby completing record filtering;
step 9: starting bill statistics by the user: inputting a to-be-counted income-expenditure category SC and a bill occurrence time range [STL, STU], encrypting the bill occurrence time range, and then uploading the encrypted bill occurrence time range and the to-be-counted income-expenditure category SC to the server;
step 10: performing, by the server, a homomorphic operation on a bill amount of each record through interaction with the trusted third party, and returning an operation result RES₂ to the user; and
step 11: performing, by the user, homomorphic decryption on the operation result RES₂ to calculate a total amount, thereby completing amount statistics.

2. The privacy-preserving method for personal bill record filtering and amount statistics according to claim 1, wherein step 2 comprises:
step 2.1: generating, by the user, a key pair (pk, sk) by using the Paillier encryption system, wherein pk represents the public key and sk represents the private key;
step 2.2: multiplying the bill amount Aᵢ by 100 to obtain a non-negative integer saᵢ, and encrypting the non-negative integer saᵢ with the public key pk by the user to obtain a ciphertext E(saᵢ), that is, an encrypted bill amount;
step 2.3: converting the occurrence time Tᵢ into a timestamp tsᵢ, and encrypting the timestamp tsᵢ with the public key pk by the user to obtain a ciphertext E(tsᵢ), that is, an encrypted time; and
step 2.4: padding a right side of the bill description string Dᵢ with null characters until a character upper limit l is reached, then encoding the padded bill description string into a positive integer dᵢ, and encrypting the positive integer dᵢ with the public key pk by the user to obtain a ciphertext E(d).

3. The privacy-preserving method for personal bill record filtering and amount statistics according to claim 2, wherein in step 3, all the homomorphically encrypted ciphertext data comprises: E(saᵢ), E(tsᵢ), and E(dᵢ); the auxiliary information comprises: the income-expenditure category C, and the bill description string length len(Dᵢ).

4. The privacy-preserving method for personal bill record filtering and amount statistics according to claim 2, wherein step 5 comprises:
step 5.1: multiplying an upper bound and a lower bound of the bill amount interval [AL, AU] by 100 to obtain corresponding non-negative integers sal and sau, and then encrypting the upper and lower bounds after the multiplication using the public key pk to obtain corresponding ciphertexts (E(sal), E(sau));
encoding and converting the keyword string K of the bill description into a non-negative integer d, and encrypting the non-negative integer d with the public key pk to obtain a ciphertext E(d);
converting an upper bound and a lower bound of the record occurrence time interval [TL, TU] into corresponding timestamps (tsl, tsu), and then separately encrypting the timestamps corresponding to the upper and lower bounds with the public key pk to obtain corresponding ciphertexts (E(tsl), E(tsu)); and
step 5.2: connecting, by the user, the three ciphertexts (E(sal), E(sau)), E(d) and (E(tsl), E(tsu)) of the three filtering conditions according to an input AND/OR condition, and then uploading the connected ciphertexts together with the bill description string length len(D₁) to the server, wherein an expression for the connection is as follows:
$$FC¡ = ( ( E ( sal ) , E ( sau ) ) , conj , E ( d ) , conj , ( E ( tsl ) , E ( tsu ) ) ) ,$$
wherein a conjunction conj=“AND” or conj=“OR”.

5. The privacy-preserving method for personal bill record filtering and amount statistics according to claim 4, wherein step 6 comprises:
step 6.1: according to the ciphertexts E(sal) and E(sau) for amount interval filtering, for the encrypted amount E(saᵢ) in each ciphertext bill, performing Paillier subtraction homomorphic operations between E(sal) and E(saᵢ), and between E(sau) and E(saᵢ) respectively, to obtain operation results denoted as αᵢ and βᵢ;
according to the ciphertext E(d) for bill description filtering, for the encrypted bill description E(dᵢ) in each ciphertext bill and for j=0, . . . , l−len(K), performing subtraction homomorphic operations between E(d<<j) and E(dᵢ), and then integrating operation results into a vector γᵢ=(γᵢ⁽⁰⁾, . . . , γᵢ^{(l-len(K))});
according to the corresponding ciphertexts E(tsl) and E(tsu) for occurrence time interval filtering, for the encrypted time E(tsᵢ) in each ciphertext bill, performing subtraction homomorphic operations between E(tsl) and E(tsᵢ), and between E(tsu) and E(tsᵢ) respectively, to obtain operation results denoted as δᵢ and εᵢ; and
step 6.2: combining, by the server, the operation results according to an AND/OR conjunction submitted by the user, wherein an expression for each operation result after the combination is as follows:
$${FR}_{i} = ( ( {α}_{i} , {β}_{i} ) , conj , {γ}_{i} , conj , ( {δ}_{i} , {ε}_{i} ) )$$
and sending all the operation results FRᵢ after the combination to the trusted third party.

6. The privacy-preserving method for personal bill record filtering and amount statistics according to claim 5, wherein step 7 comprises:
step 7.1: performing, by the trusted third party, homomorphic decryption on each operation result FRᵢ by using the private key sk to obtain a result:
$$D ( {FR}_{i} ) = ( ( D ( {α}_{i} ) , D ( {β}_{i} ) ) , conj , D ( {γ}_{i} ) , conj , ( D ( {δ}_{i} ) , D ( {ε}_{i} ) ) ) ;$$
when D(αᵢ)<0 and D(βᵢ)>0, adding a current index i into a hit index set AI for amount filtering;
when a decoding result of each component of the vector D(γᵢ) has a character-wise Hamming weight not exceeding len(Dᵢ)−len(K), adding the current index i into a hit index set DI for bill description filtering;
when D(δᵢ)<0 and D(εᵢ)>0, adding the current index i into a hit index set TI for time filtering; and
step 7.2: calculating, by the trusted third party, an intersection or a union of the three hit index sets AI, DI, and TI according to the conjunction conj=“AND” or conj=“OR” to form a result index set I, and returning the result index set I to the server.

7. The privacy-preserving method for personal bill record filtering and amount statistics according to claim 6, wherein step 8 comprises:
step 8.1: recording, by the server, corresponding ciphertext bills according to the index set I returned by the trusted third party, to form a result RES₁, and sending the result to the user; and
step 8.2: after receiving the result RES₁, decrypting, by the user, E(saᵢ), E(tsᵢ), and E(dᵢ) corresponding to each record by using the private key sk, to obtain the multiplied amount saᵢ, the timestamp tsᵢ, and the integer dᵢ; then reducing saᵢ by 100 times to obtain an actual amount aᵢ, converting the timestamp tsᵢ to the occurrence time Tᵢ, and decoding the integer dᵢ and removing the null characters on the right side to obtain D, thereby completing record filtering.

8. The privacy-preserving method for personal bill record filtering and amount statistics according to claim 2, wherein step 9 comprises:
step 9.1: inputting, by the user, the to-be-counted income-expenditure category SC and the bill occurrence time range [STL, STU]; and
step 9.2: converting, by the user, an upper bound and a lower bound of the bill occurrence time range [STL, STU] into timestamps tssl and tssu respectively, encrypting the timestamps corresponding to the upper and lower bounds with the public key pk to obtain corresponding ciphertexts (E(tssl), E(tssu)), and submitting the ciphertexts (E(tssl), E(tssu)) of the bill occurrence time range and the income-expenditure category SC to the server.

9. The privacy-preserving method for personal bill record filtering and amount statistics according to claim 8, wherein step 10 comprises:
step 10.1: performing, by the server according to the corresponding ciphertexts E(tssl) and E(tssu) of the bill occurrence time range, Paillier subtraction homomorphic operations between E(tssl) and E(tsᵢ), and between E(tssu) and E(tsᵢ) for the encrypted time E(tsᵢ) in each ciphertext bill, to obtain operation results λᵢ and μᵢ, and sending the operation results to the trusted third party;
step 10.2: decrypting, by the trusted third party, each λᵢ and μᵢ by using the private key sk; when D(λᵢ)<0 and D(μᵢ)>0, adding the current index i into the hit index set TI, and finally returning TI to the server; and
step 10.3: performing, by the server according to the hit index set TI and the to-be-counted income-expenditure category SC submitted by the user, an additive homomorphic operation on the encrypted amount in each ciphertext bill that meets the to-be-counted income-expenditure category and the hit index set TI, and returning an operation result RES₂ to the user.

10. The privacy-preserving method for personal bill record filtering and amount statistics according to claim 9, wherein step 11 comprises: performing, by the user, homomorphic decryption on the operation result RES₂ to obtain the total amount, then reducing the total amount by 100 times to complete the amount statistics, and generating a final query result.
